(19) United States
(12) Patent Application Publication
(10) Pub. No.: US 2003/0130767 A1
(43) Pub. Date: Jul. 10, 2003

(54) Method of and apparatus for acquiring aerial imagery for precision farming

(76) Inventor: Ernest A. Carroll, Herndon, VA (US)

Correspondence Address: Ernest A. Carroll, 12913 Alton Square, No. 114, Herndon, VA, 20170, US

(21) Appl. No.: 10/036,417

(22) Filed: Jan. 7, 2002

(51) Int. Cl. G01C 21/00

(52) U.S. Cl. 701/3; 701/213; 342/357.17

(57) ABSTRACT

A method of practicing precision farming wherein a ground launched, air breathing, powered, unmanned miniature aircraft overflies a field being surveyed to acquire aerial imagery of the same. The flight path of the aircraft is controlled at least partially by automated control apparatus carried aboard the aircraft, and preferably includes radio signal inputs from the GPS. The flight path includes alternating turns assuring that as much of the field as possible be overflown in one flight. Where necessary, plural complementary flights are conducted. The aircraft is preferably controlled to land at a predetermined site which may be outside of the field being surveyed and which may be its own launch site. Preferably, a redundant navigation system utilizing altitude, air speed, and pitch and roll sensors supplements the GPS inputs. Acquired images may be multispectral, hyperspectral, ultraspectral, thermal, synthetic aperture radar, or laser radar, or any combination thereof. The imagery is analyzed after acquisition to determine localized needs. An agricultural operation such as for example application of water, seed, herbicide, pesticide, fungicide, or performing for example an operation such as pruning or harvesting, is then performed according to the need as determined by the analysis.

Other decisions which are part of farming include deciding when to prune, when to harvest, and how to manage water run off. Still other factors which would be beneficial to determine as soon as possible include such things as crop yield, crop damage (e.g., as a consequence of heat spells, freezes, drought, pests, etc.). Scheduling of subsequent steps in farming, such as tilling, harvesting, managing water run off, storing water, and erecting water distribution apparatus, may be established when relevant information becomes available.

Aerial reconnaissance is the most practical way of gathering data which may be used to implement decisions to apply resources and to conduct other steps in farming. Aerial reconnaissance is practiced, but suffers from being expensive and further is impractical to conduct in certain instances, due largely to regulation of restrictions to aircraft of weights exceeding fifty-five pounds. Even where not restricted, manned aircraft are reliant upon suitable take off and landing sites, and may possibly require flying from distant sites in order to reach a field of interest. Obviously, “dead heading”, or flying of aircraft merely to get to a field being surveyed, is non-productive, while incurring fuel and other costs. Satellite imagery can be used, but satellite platforms are expensive and not easily rerouted from orbital paths, should the latter be necessary to capture images of a particular location.

The prior art leaves a need for a practical, low cost solution to the problem of gathering of imagery for precision farming purposes.

### SUMMARY OF THE INVENTION

The present invention sets forth a method of acquiring aerial imagery for use in precision farming, utilizing a miniature aircraft. As employed herein, a miniature aircraft will be understood to be of dimensions too small to accommodate a human occupant, and sufficiently light as to remain under the threshold of fifty-five pounds above which civil authorities currently impose certain restrictions. The aircraft carries suitable image acquisition apparatus thereaboard. The image acquisition apparatus preferably includes a digital camera and a microprocessor having memory for storing imagery as data and programming for controlling the flight path of the aircraft. The camera selectively captures multispectral, hyperspectral, and ultraspectral images. In alternative embodiments, the image acquisition apparatus may be of a type selectively able to capture thermal imagery or imagery from synthetic aperture radar, laser radar, and other forms of energy, with appropriate modification made to the image acquisition apparatus, where the latter cannot use a digital camera.

A significant advance is that of employing miniature, unmanned aircraft. This step greatly reduces costs of acquiring imagery. Miniature aircraft cost less to purchase, maintain, and operate than do full size aircraft which accommodate human occupants. Also, they are not restricted as far as storage and take off or launch. Miniature aircraft are also not restricted as regards being allowed to overfly certain types of facilities. Full size aircraft are, for example, banned over certain populated facilities, and require runways of great length to take off. By contrast, miniature aircraft can be carried to a predetermined launch site in a private motor vehicle, and may be launched without a runway. As a consequence, exploitation of aerial imagery is readily and inexpensively brought to many venues which would not be practical or economically feasible using full size aircraft.

In a further advance, flight of miniature aircraft may be controlled autonomously from direct human or hands-on control. This may be accomplished by preprogrammed control procedures utilizing a microprocessor carried aboard the aircraft, by transmitting radio frequency control signals to the aircraft, by utilizing on-board sensors which monitor flight characteristics, or by any combination of these techniques. For example, certain basic steps may be carried in software loaded into the microprocessor, while overriding commands and location signals obtained, for example, from an existing navigation system such as the Global Positioning System, may be transmitted to provide final flight parameters.

The flight can be readily controlled so that the aircraft lands at a predetermined site, which may be within or outside the field being surveyed, and which may be the launch site of the aircraft.

The types of acquired aerial images may be multispectral, hyperspectral, ultraspectral, thermal, obtained from synthetic aperture radar, laser radar, or any other convenient form of radiant energy. Once acquired, aerial imagery may be analyzed to determine requirements of the field being surveyed so that subsequent agricultural operations may be performed in a manner advantageously exploiting knowledge of localized conditions as determined by analysis of the imagery.

Accordingly, it is one object of the invention to enable low cost aerial reconnaissance to be conducted in practicing precision farming.

It is another object of the invention to provide an aircraft for use in aerial reconnaissance for precision farming which need not be operated by human personnel and is not subject to many restrictions applying to manned aircraft.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a diagrammatic side elevational view of a miniature aircraft for acquiring aerial imagery.

FIG. 2 is a diagrammatic plan view of an agricultural field being surveyed utilizing the aircraft of FIG. 1.

FIG. 3 is a diagrammatic view of the aircraft of FIG. 1, wherein an alternative embodiment of the sensor captures thermal images.

FIG. 4 is a diagrammatic view of the aircraft of FIG. 1, wherein a further alternative embodiment of the sensor utilizes laser radar.

FIG. 5 is a diagrammatic view of the aircraft of FIG. 1, wherein still another alternative embodiment of the sensor uses synthetic aperture radar.

### DETAILED DESCRIPTION OF THE PREFERRED EMBODIMENTS

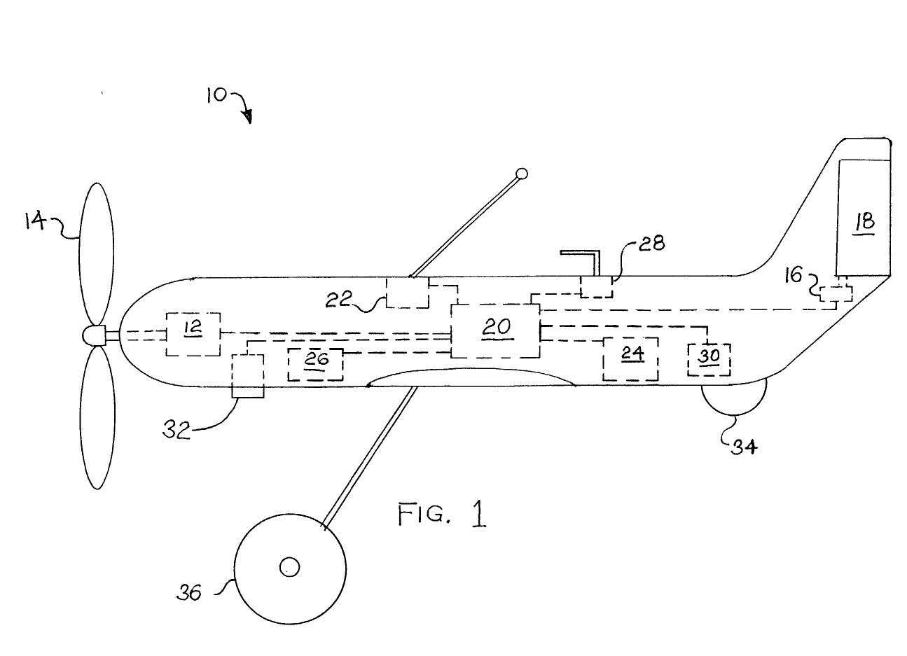

Turning now to FIG. 1 of the drawings, apparatus which is provided for practicing the invention is seen to include an air breathing, self-powered miniature aircraft 10 having image acquisition apparatus carried thereaboard. Aircraft 10 may be of the type known as model aircraft, which aircraft are readily available to the general public in both assembled and unassembled form. Construction of airframes of small scale aircraft is well known and therefore will be set forth in limited detail herein. Aircraft 10 is provided with a miniature air breathing engine 12, which may be for example of a reciprocating piston, internal combustion two stroke or four stroke type. Engine 12 will be understood to include a suitable fuel tank (not shown) and other necessary apparatus to support operation. Engine 12 is arranged to rotate a propeller 14.

Aircraft 10 is provided with automated flight control apparatus thereaboard. This control apparatus includes an electrically operated servo 16, for operating flap 18. One servo 16 and one flap 18 are shown in representative capacity, but are understood to be provided in sufficient quantity and location as to be able to control aircraft 10 to fly in any selected flight path. Servo 16 and flap 18 may be for example of the type conventionally employed for model aircraft (not shown) flown by hobbyists under radio control.

Conventional radio operated controllers (not shown) of model aircraft may be utilized if desired. However, it is preferable to provide a microprocessor 20 having associated programming aboard aircraft 10. Microprocessor 20 will be understood to include suitable memory devices (not separately shown) operably connected thereto. A radio frequency receiver 22 receives input signals and transmits the same to microprocessor 20. Microprocessor 20 is disposed to control the automated flight control apparatus to achieve a predetermined flight path. To this end, the flight control apparatus includes a power supply, which may be a battery 24, an engine driven generator (not shown), or a combination of both battery 24 and generator. Microprocessor 20 generates control signals corresponding to those conventionally provided remotely by radio by hobbyists operating model aircraft. The control signals are amplified to be of suitable magnitude to operate servo 16 under flight conditions. This may be accomplished in any suitable way, such as by utilizing amplifiers, relays, or any other well known electrical control components (none shown).

Radio frequency receiver 22 can receive both command signals generated by personnel operating aircraft 10 and also signals from a navigational position signal system such as the Global Positioning System (GPS). Microprocessor 20, which is disposed in communication with radio frequency receiver 22, can be controlled by pre-programmed flight instructions, real time flight control commands, or either or both of these together with location inputs derived either from the navigational position signal system.

As a supplement to the GPS, aircraft 10 is preferably provided with a redundant navigation system which complements location determination provided by utilizing location signals from the GPS. The redundant navigation system includes a barometric altitude sensor 26, an airspeed sensor such as pitot tube 28, and roll and pitch sensors 30. Sensors 26, 28, 30 are operably connected to microprocessor 20. Location may be determined where GPS signals are ineffective by utilizing data obtained from sensors 26, 28, 30.

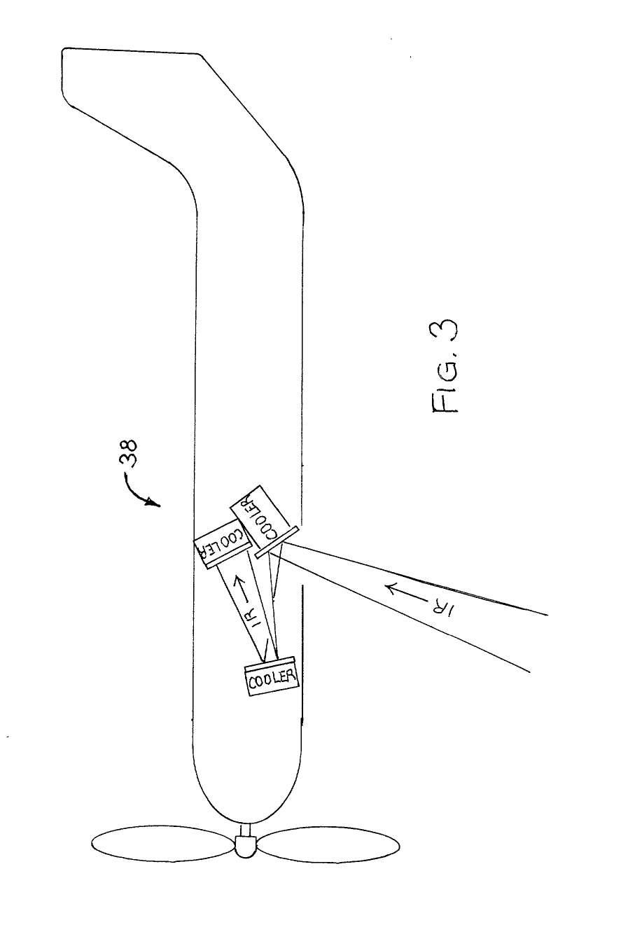

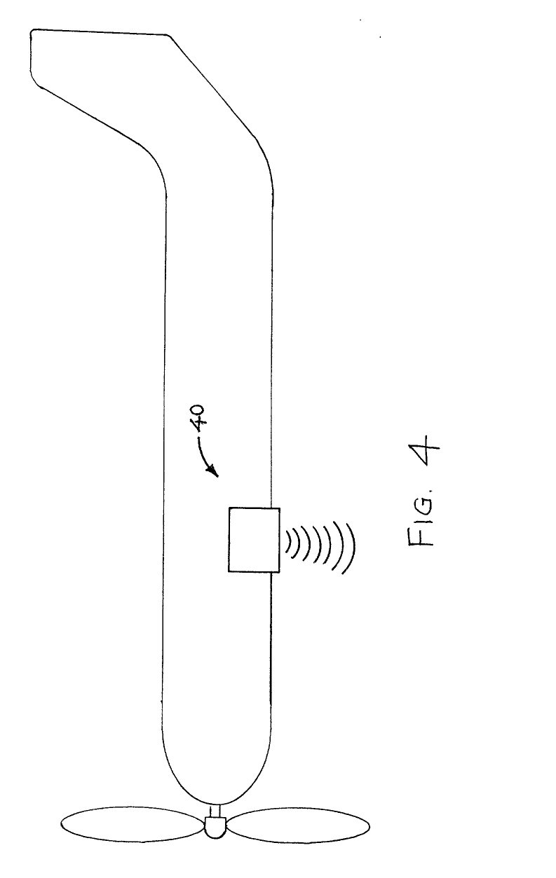

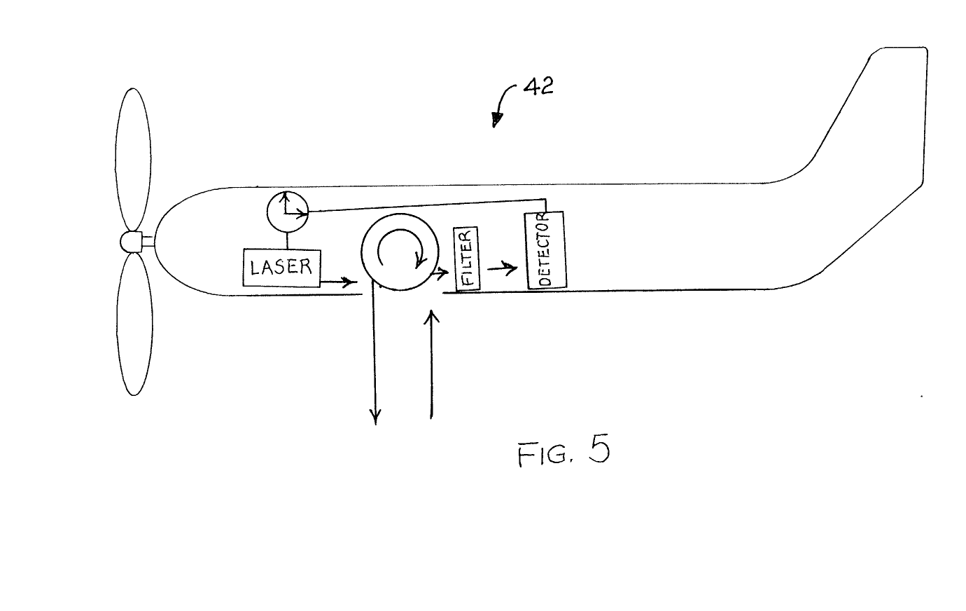

Aircraft 10 also has image acquisition apparatus 32 carried on board. Apparatus 32 may comprise, for example, a digital camera for obtaining multispectral, hyperspectral, and ultraspectral images. An example of a suitable camera which may be installed in and operated from aircraft 10 is described in co-pending patent application Ser. No. 09/796,365, filed Mar. 2, 2001, which is included herein by reference. As an alternative or in addition to the digital camera, apparatus 32 could comprise thermal or infrared image acquisition apparatus 38 (see FIG. 3), synthetic aperture radar image acquisition apparatus 40 (see FIG. 4), laser radar image acquisition apparatus 42 (see FIG. 5), or any other suitable type of image acquisition apparatus. Sensors 38, 40, 42 may utilize known structure to achieve their functions, and further will be understood to include operable connection to microprocessor 20 and to electrical power, which may supplied by battery 24 or by direct connection to the engine driven generator. While sensors 38, 40, 42 of respective embodiments of FIGS. 3, 4, and 5 vary, the airframe, power plant and propeller, and communications and control equipment of these embodiments may be the same as those of the embodiment of FIG. 1.

Apparatus 32, where a digital camera is not sufficient, will be understood to include all necessary elements for operability. For example, thermal image acquisition apparatus will be understood to include a source of cooling, for reducing recorded background thermal noise below the threshold necessary to record heat emissions from the subject of the survey. The source of cooling may be a supply of expansible refrigerant, or alternatively, as may be required for larger scale projects, an engine powered cooler. Apparatus 32 may comprise additional data processing capability, provided by additional memory devices, microprocessors, or additional connections to a microprocessor and memory devices which primarily serve other purposes such as flight guidance and image storage. For laser radar, apparatus 32 will encompass a laser generator, rotatable reflector, holographic scanner, and other components required for operability.

Aircraft 10 is preferably provided with landing gear including wheels 34, 36, for enabling take offs and landings on flat ground.

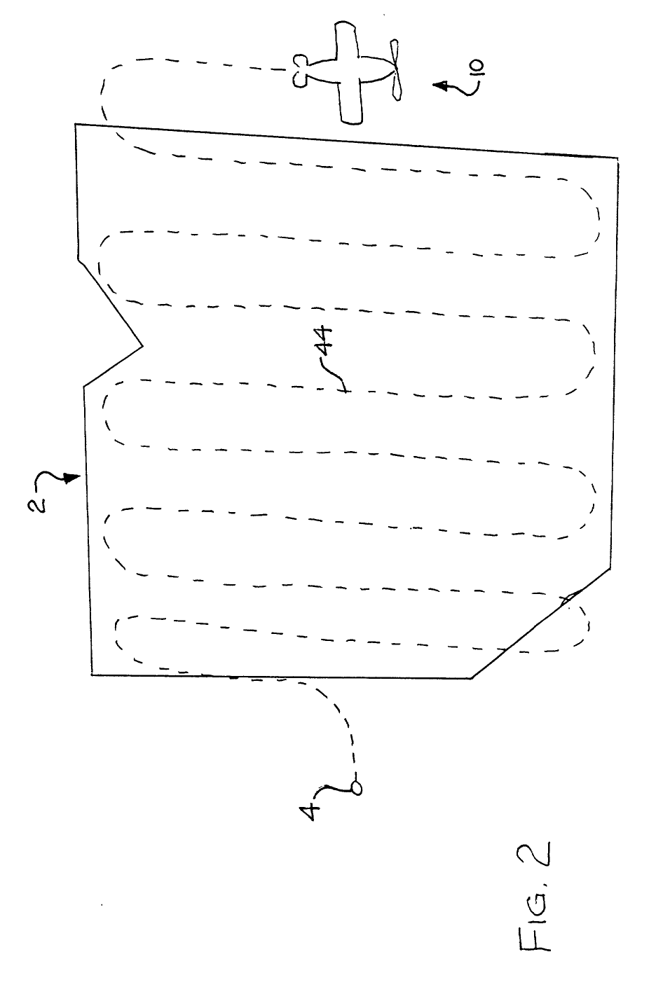

Aircraft 10 is utilized in the following manner, referring also to FIG. 2. A selected agricultural field 2 is surveyed by overflying field 2 utilizing aircraft 10 to acquire at least one image of field 2. Field 2 will be understood to be an agricultural land area of interest which may include more or less than one actual field 2 being cultivated. In most cases, many images will be acquired to enable close scrutiny of localized conditions. Aircraft 10 is brought to a suitable launch site 4, which may be within or alternatively outside of field 2. After engine 12 is operating, aircraft 10 is launched from the ground or from a launch platform (not shown) supported on the ground. The launch platform may be a static structure, a motor vehicle, or any suitable device for launching aircraft 10. In most cases, aircraft 10 will be launched in conventional fashion by taxiing on the ground entirely under its own power and becoming airborne as sufficient lift develops. Regardless of the specific method of launching, aircraft 10 is caused to gain altitude under its own power, utilizing engine 12 and propeller 14.

If the fuel supply is adequate, then field 2 may be overflown in a single flight. If a field is sufficiently large, then plural complementing flights will be conducted, wherein each flight may or may not overlap area of coverage of other flights. Complementing flights may be performed by utilizing several aircraft, or alternatively, utilizing one aircraft in sequential flights.

In most cases, it will be desirable to overfly field 2 by causing aircraft 10 to fly in a sweeping pattern wherein flight of aircraft 10 is controlled to include at least a first turn in one direction and a second turn in an opposed direction. As shown in FIG. 2, the sweeping pattern, indicated by broken line 44, includes many turns in alternating directions to assure sufficiently detailed coverage of every part of field 2.

When a flight is to be terminated after overflying and surveying field 2, aircraft 10 is caused to fly under control to a predetermined location. For convenience, the predetermined location is proximate the launch site 4 of aircraft 10. Launch site 4 is outside field 2, but may be located on field 2 if desired.

After images are acquired and retrieved from aircraft 10, the images are analyzed to determine local conditions of field 2 and requirements thereof relative to an agricultural operation. Once requirements are determined, the agricultural operation is conducted in a manner corresponding to these requirements as determined in the analysis. The agricultural operation may include any operation related to agriculture, which is an operation related to managing resources. Results from application of agricultural resources can be optimized by applying the resources according to local need rather than uniformly, as had been practiced prior to the advent of precision farming. In accordance with economies achieved by precision farming, the phase of acquiring data for analysis is automated and greatly reduced in costs compared to prior art practice in precision farming by the methods set forth above and described in the appended claims.

It will be appreciated that the invention is susceptible to variations and modifications which may be introduced thereto. For example, elements described in the singular may be replaced by plural elements, and where practical, the opposite may be performed.

It is to be understood that the present invention is not limited to the embodiments described above, but encompasses any and all embodiments within the scope of the following claims.

I claim:

1. A method of practicing precision farming wherein at least one agricultural operation is to be conducted with respect to a predetermined agricultural field, comprising the steps of:
providing an air breathing, self-powered miniature aircraft having image acquisition apparatus carried thereaboard;
surveying the agricultural field by acquiring at least one image of then agricultural field from the image acquisition apparatus carried aboard the miniature aircraft;
analyzing the at least one image obtained in said step of surveying the agricultural field to determine at least one local condition of the agricultural field and at least one requirement of the agricultural field relative to an agricultural operation; and
conducting the agricultural operation with respect to the agricultural field in a manner corresponding to the at least one requirement of the agricultural field as determined in said step of analyzing the at least one image.

2. The method according to claim 1, wherein said step of conducting an agricultural operation comprises the further step of applying at least one agricultural resource to the agricultural field according to at least one requirement determined in said step of analyzing the at least one image.

3. The method according to claim 1, wherein said step of surveying the agricultural field comprises the further step of causing the aircraft to gain altitude under its own power.

4. The method according to claim 3, wherein said step of surveying the agricultural field comprises the further step of launching the aircraft from the ground.

5. The method according to claim 1, comprising the further step of launching the aircraft entirely under its own power.

6. The method according to claim 1, wherein said step of surveying the agricultural field comprises the further step of controlling the flight path such that the entire agricultural field being surveyed is overflown in a single flight.

7. The method according to claim 6, wherein said step of controlling the flight path of the aircraft comprises the further step of causing the aircraft to fly in a sweeping pattern wherein flight of the aircraft is controlled to include at least a first turn in one direction when overflying the agricultural field and a second turn in an opposed direction when overflying the agricultural field.

8. The method according to claim 6, comprising the further step of providing automated flight control apparatus aboard the aircraft and a microprocessor having programming aboard the aircraft, wherein the microprocessor is disposed to control the automated flight control apparatus to achieve a predetermined flight path.

9. The method according to claim 8, comprising the further steps of
providing a radio frequency receiver disposed to communicate with a Global Positioning System, wherein the radio frequency receiver is disposed in communication with the microprocessor, and
utilizing location signals from the Global Positioning System to control at least partially the flight path of the aircraft.

10. The method according to claim 9, comprising the further step of providing a redundant navigation system complementing location determination provided by said step of utilizing location signals from the Global Positioning System.

11. The method according to claim 10, comprising the further steps of:
providing the miniature aircraft with a barometric altitude sensor, an airspeed sensor, and roll and pitch sensors;
operably connecting the barometric altitude sensor, the airspeed sensor, and the roll and pitch sensors to the microprocessor; and
determining location by utilizing data obtained from the barometric altitude sensor, the airspeed sensor, and the roll and pitch sensors.

12. The method according to claim 1, wherein said step of surveying the agricultural field comprises the further step of conducting plural complementing flights over the agricultural field being surveyed.

13. The method according to claim 12, wherein said further step of conducting plural complementing flights comprises the further step of utilizing at least one additional miniature aircraft.

14. The method according to claim 12, wherein said step of controlling the flight path of the aircraft comprises the further step of causing the aircraft to fly in a sweeping pattern wherein flight of the aircraft is controlled to include at least a first turn in one direction when overflying the agricultural field and a second turn in an opposed direction when overflying the agricultural field.

15. The method according to claim 12, comprising the further step of providing automated flight control apparatus aboard the aircraft and a microprocessor having programming aboard the aircraft, wherein the microprocessor is disposed to control the automated flight control apparatus to achieve a predetermined flight path.

16. The method according to claim 15, comprising the further steps of
providing a radio frequency receiver disposed to communicate with a Global Positioning System, wherein the radio frequency receiver is disposed in communication with the microprocessor, and
utilizing location signals from the Global Positioning System to control at least partially the flight path of the aircraft.

17. The method according to claim 16, comprising the further step of providing a redundant navigation system complementing location determination provided by said step of utilizing location signals from the Global Positioning System.

18. The method according to claim 17, comprising the further steps of:
providing the miniature aircraft with a barometric altitude sensor, an airspeed sensor, and roll and pitch sensors;
operably connecting the barometric altitude sensor, the airspeed sensor, and the roll and pitch sensors to the microprocessor; and
determining location by utilizing data obtained from the barometric altitude sensor, the airspeed sensor, and the roll and pitch sensors.

19. The method according to claim 1, comprising the further step of causing the aircraft to fly under control to a predetermined location after overflying the agricultural field being surveyed.

20. The method according to claim 1, comprising the further step of causing the aircraft to fly under control to a location outside of the agricultural field being surveyed.

21. The method according to claim 1, comprising the further step of causing the aircraft to fly under control to a location proximate its launch location.

22. The method according to claim 1, wherein said step of surveying the agricultural field comprises the further step of acquiring a plurality of multispectral images of the agricultural field from the aircraft.

23. The method according to claim 1, wherein said step of surveying the agricultural field comprises the further step of acquiring a plurality of hyperspectral images of the agricultural field from the aircraft.

24. The method according to claim 1, wherein said step of surveying the agricultural field comprises the further step of acquiring a plurality of ultraspectral images of the agricultural field from the aircraft.

25. The method according to claim 1, wherein said step of providing an air breathing, self-powered miniature aircraft having image acquisition apparatus carried thereaboard comprises the further step of providing thermal image acquisition apparatus thereaboard.

26. The method according to claim 1, wherein said step of providing an air breathing, self-powered miniature aircraft having image acquisition apparatus carried thereaboard comprises the further step of providing synthetic aperture radar image acquisition apparatus thereaboard.

27. The method according to claim 1, wherein said step of providing an air breathing, self-powered miniature aircraft having image acquisition apparatus carried thereaboard comprises the further step of providing laser radar image acquisition apparatus thereaboard.
